(19) United States
(12) Patent Application Publication
(10) Pub. No.: US 2012/0317384 A1
(43) Pub. Date: Dec. 13, 2012

(54) DATA STORAGE METHOD

(75) Inventors: Alejandro Bascunana Munoz, Torrevieja (Alicante) (ES); Gabriel Huecas, Madrid (ES); Alberto Mozo, Madrid (ES); Juan Quemada, Madrid (ES); Joaquin Salvachua, Madrid (ES)

(73) Assignee: TELEFONAKTIEBOLAGET L M ERICSSON (PUBL), Stockholm (SE)

(21) Appl. No.: 13/577,464

(22) PCT Filed: Feb. 9, 2010
(86) PCT No.: PCT/EP10/51602

§ 371 Date: Aug. 7, 2012

(51) Int. Cl. G06F 12/16

(52) U.S. Cl. 711/162; 711/E12.103

(57) ABSTRACT

There is provided a method for storing data in a database comprising a first and a second memory. The method comprises reading a first page of data from the second memory, modifying at least part of the data read from said first page with the data to be stored in said database, writing the modified data to a second page of data in the first memory, and copying the second page from the first memory to the second memory. The data in the second page are sequentially ordered based upon the order in which the data were modified.

### TECHNICAL FIELD

The present invention relates to methods for storing data in a database and more particularly relates to methods for updating records in a relational database and adding new records to a relational database.

### BACKGROUND

Many modern applications require storage of large amounts of data. Generally, data is stored in one or more structured collections of data collectively referred to as a database. In order to manage the large quantities of data stored in modern databases, it is common to use a Database Management System to facilitate the creation and maintenance of a database.

A common type of database is a relational database. A relational database represents data as a collection of relations. Each relation comprises a plurality of tuples, each tuple providing values for common attributes. Each relation is represented by a table organized into rows and columns. Each row of a table represents a tuple of the relation and each column represents the attributes of that relation.

Tuples are stored in a computer system as “records”. Each tuple attribute value is represented by a sequence of bytes within a record, referred to as a field.

Relational Database Management Systems (RDBMS) execute query operations provided by a user application. Query operations are executed on database records stored in a main memory of the computer. Due to the need for rapid access to data, main memory is generally provided by Random Access Memory (RAM). While providing the requisite fast access times, the types of RAM commonly used to provide main memory are volatile storage technologies, requiring power to store information. Further, the relatively high cost of RAM means that, for reasonably large databases, the main memory is insufficiently large to store all records of all tables of a database.

As such, database tables are also stored in a secondary memory, generally provided by slower but higher capacity, non volatile storage devices such as hard disk drives.

Where it is desired to read or modify a record of a database, it is first determined whether that record is present in main memory. If a particular record is not present in main memory, it is located in secondary memory and copied to main memory for processing. Where main memory has insufficient free space to store an additional record copied from secondary memory, it is necessary to determine which of the records stored in main memory should be ejected to create space to store the additional record copied from the secondary memory. If the record chosen for ejection from main memory has been modified whilst in main memory, the modified record is copied back to secondary memory in order to ensure that changes are not lost when the record is ejected from main memory.

Data is stored in memory in collections of eight bits, each of which is called a byte. Disks are logically arranged into fixed size groups of a set number of bytes, generally known as “blocks”. Operations to read data from and write data to a disk are collectively known as I/O operations, and it is generally more efficient to read and write a whole number of blocks in each I/O operation.

Records included in tables of a database are stored in groups called pages. Often, the size of the pages of a database is selected to match the block size of the hard disk on which the database is stored, such that records of a database are copied between the hard disk and the main memory in whole pages rather than individual records, thereby maximizing the efficiency of record transfer between the main and secondary memory. That is, when a particular record is required, the page containing that record is copied from the secondary memory to the main memory. If the record is modified, the whole page (including the modification) is copied from the main memory to the secondary memory.

It is often the case that once a page has been copied from the secondary memory into the main memory, only one, or a small subset, of the records contained in that page is modified. The need to copy the entire page back to secondary memory therefore results in a large number of unmodified records also being written to secondary memory, and therefore considerable inefficiency.

It is an object of the present invention to obviate or mitigate at least one of the problems outlined above.

### SUMMARY

According to a first aspect of the present invention, there is provided a method for storing data in a database in a system comprising a first and a second memory, the method comprises: reading a first page of data from the second memory; modifying at least part of the data read from the second memory to create modified data to be stored in the database; writing the modified data to a second page of data in the first memory; and copying the second page from the first memory to the second memory; wherein data in the second page is sequentially ordered based upon the order in which the data was modified.

The first and second pages of data may contain a plurality of database records. The modified data may comprise one or more database records. The modified data which is written to the second page may comprise data based at least in part upon at least part of one of the records of the first page.

By storing data (e.g. database records) in said second page in an order based upon an order in which data is modified, the need to maintain log files of the type used by conventional logging and checkpointing processes is obviated.

Further, the methods described herein are advantageous in requiring a reduced number of page copy operations from first memory to second memory. For example, if a page can allocate K records on average, then with the proposed invention, K record modifications result in only a single page being copied from first memory to secondary memory. In traditional database management systems with large databases having a near random access pattern, it is expected that on average, K record modifications will result in K pages being copied to secondary memory.

Writing the modified data to the second page may comprise appending the data to data previously written to the second page.

An index may reference records in the first page read from the second memory and the method may further comprise modifying an entry in the index to reference the second page to which the data is written. That is, where there is an index to records stored in a database according to aspects of the present invention, modification of a record of that database may require the index entry corresponding to the modified record to be updated to indicate the new position of the record. For example, where an index references records using a page number and an offset in that page, modification of a record as described above will require that the index entry corresponding to that record is updated to refer to the new page and the offset at which the record is stored within that page.

The method may further comprise adding to the second page a new database record, not contained in the read first page, comprising new data to be stored in the database. That is, writing data may comprise writing new records, or writing data representing modifications to existing records. In both cases, the data is written in order of its creation or modification.

The second page may be copied to the second memory when a predetermined quantity of data has been written to the second page. For example, when the second page is full (i.e. all its records comprise newly created data, or modified data) it can then be “flushed” to the second memory. The second page can then be emptied in the first memory. There is therefore no need to maintain undo/redo logs because “flushing” can be carried out on the fly, when the second page becomes full.

A further second page may be created when a predetermined quantity of data has been written to the second page. Data stored in the further second page may be sequentially ordered based upon the order in which the data is modified.

The first memory may have a first associated access time and the second memory may have a second associated access time, with regard to data read and/or write operations. The first access time may be less than the second access time. The first memory may be a volatile memory, while the second memory may be a non-volatile memory. For example, the first memory may be, for example, volatile random access memory (RAM), and the first access time may be of the order of 1000 times faster than the second access time. The second memory may be, for example, a hard disk drive.

The method may further comprise processing a plurality of pages stored in the second memory to identify obsolete and non-obsolete versions of the same data included in the plurality of pages; rearranging data within a first one of the plurality of pages so that non-obsolete data is contiguously arranged; copying non-obsolete data from another of the plurality of pages to the first one of the plurality of pages, overwriting obsolete data in the first one of the plurality of pages but maintaining non-obsolete data in the first one of the plurality of pages. Such processing may result in one or more of the plurality of pages having only obsolete data. Pages containing only obsolete data can be “freed” in order to free space in the second memory.

The method may further comprise, storing in the second page data indicating transaction commencement and completion.

The method may further comprise processing the data indicating transaction commencement and completion to identify partially executed transactions.

The method may further comprise reading the data stored in the second page; modifying the data read from the second page; and writing the modified data to the second page or to a further second page without affecting the data which was read.

By storing data in a database according to the method described above, logging occurs implicitly because each insertion of a new record, or modification of an existing record, results in the allocation of a new record in a last page to which data is being written.

It will be appreciated that aspects of the invention can be implemented in any convenient form. For example, the invention may be implemented by appropriate computer programs which may be carried out appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

### BRIEF DESCRIPTION OF THE DRAWINGS

Embodiments of the invention will now be described, by way of example, with reference to the accompanying drawings, in which:

FIG. 1 is a schematic illustration of a computer system on which an embodiment of the invention is implemented;

FIG. 2 is a flowchart showing operation of an embodiment of the invention at a high level;

FIG. 3 is a schematic illustration showing how data is stored in a main memory of the computer system of FIG. 1;

FIG. 4 is a flowchart showing processing carried out to add a record to a database;

FIG. 5 is a flowchart showing processing carried out to modify a record in a database;

FIG. 6 is a schematic illustration showing how modification of a data record affects data stored in the main memory of the computer system of FIG. 1;

FIG. 7 is a schematic illustration of a full page of records stored in the main memory of the computer system of FIG. 1;

FIG. 8 is a flowchart showing processing carried out to identify and eliminate redundant records stored in the secondary memory;

FIG. 9 is a schematic illustration showing how the processing of FIG. 8 affects the position of records in pages of a database; and

FIG. 10 is a flowchart showing processing carried out to ensure transactional atomicity.

### DETAILED DESCRIPTION

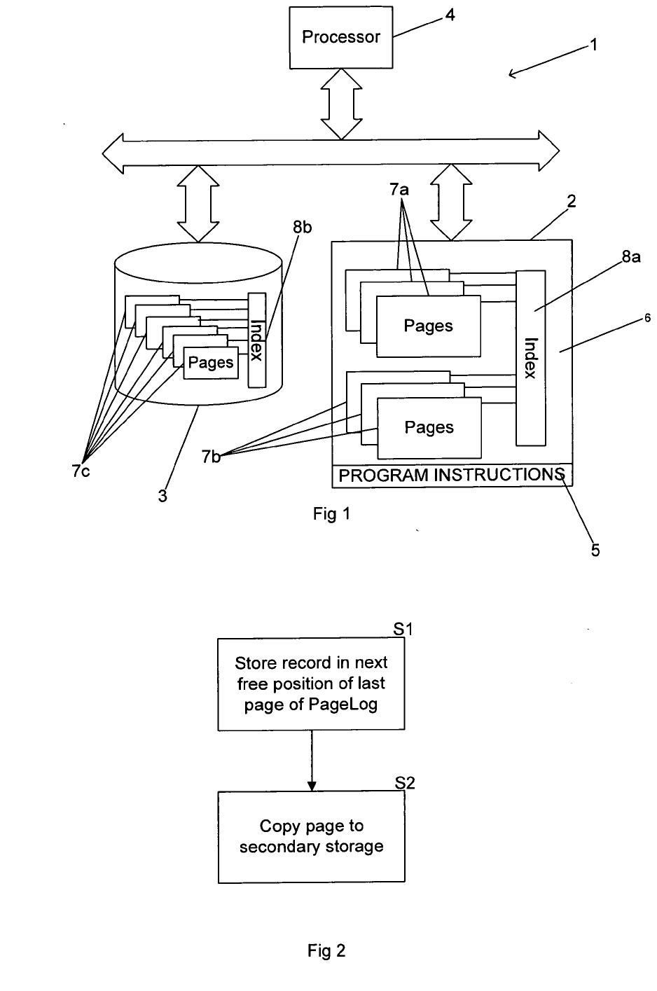

FIG. 1 shows a computer 1 arranged to implement an embodiment of the invention. The computer 1 comprises a main memory 2 provided by RAM and a secondary memory 3 provided by a hard disk drive. A processor 4 is arranged to read and execute instructions stored in a first logical part 5 of the main memory 2. Data manipulated by those instructions is stored in a second logical part 6 of the main memory 2. The instructions stored in the first logical part 5 of the main memory 2, amongst other things, control the processor 4 to copy data between the second logical part 6 of the main memory 2 and the secondary memory 3.

The instructions stored in the first logical part 5 of the main memory 2 control the processing of data stored in the main memory 2 which forms part of a relational database stored in the secondary memory 3. Data of the relational database is stored in both the main memory 2 and the secondary memory 3 in the form of a plurality of pages 7, each page comprising a predetermined quantity of data in the form of database records

In order to allow user applications executed by the processor 4 to efficiently locate particular records of a particular database table, each of the main memory 2 and the secondary memory 3 store an additional data structure called an index 8a, 8b. Each index 8a, 8b is an ordered list of record references using some record field as an ordering criteria. Each database table has at least one index to allow traversal across all records of the database table. The ordering criteria of the index is established using a non-null value attribute, referred to as a ‘key’, of the table. Each time a record is inserted into or deleted from a table, the associated table index is updated. A record reference is saved in each index cell to allow access to a respective record when traversing an index. This reference is usually known as an “rid” (record identifier) and is composed of a page number and an internal byte offset from the first byte of the page where the record is allocated. For example, if a record is stored at the eighth byte of page two, the rid will specify page two and an offset of eight.

Data is transferred between the secondary memory 3 and the main memory 2 in pages of predetermined size. Data is transferred from the secondary memory 3 to the main memory 2 when required by a user application being executed by the processor 4. Data is transferred from the main memory 2 to the secondary memory 3 for persistent storage.

Pages 7a stored in the main memory 2 are pages which have been copied to the main memory 2 from the secondary memory 3. Pages 7b stored in the main memory 2 store modifications to records stored in the secondary memory 3 and/or records which are to be added to records stored in the secondary memory 3. As such, the pages 7b are those which need to be copied from the main memory 2 to the secondary memory 3. The pages 7a need not be copied back to the secondary memory 3 (even if the pages 7a are deleted from the main memory 2) because records in these pages are already stored in the secondary memory 3, and any additions or modifications are stored in one of the pages 7b. The pages 7b are hereinafter referred to as a page log.

FIG. 2 shows processing carried out by the processor 4 to store data in the database. At step S1 a record (representing a modification to an existing record or an entirely new record) is stored at the end of a page 7b of the page log to which data is currently being added. When this page 7b is full (i.e. has no space for the storage of further records) the page is copied to the secondary memory 3 for persistent storage at step S2. The records in the page 7b are ordered according to the temporal order in which those records were modified and/or created.

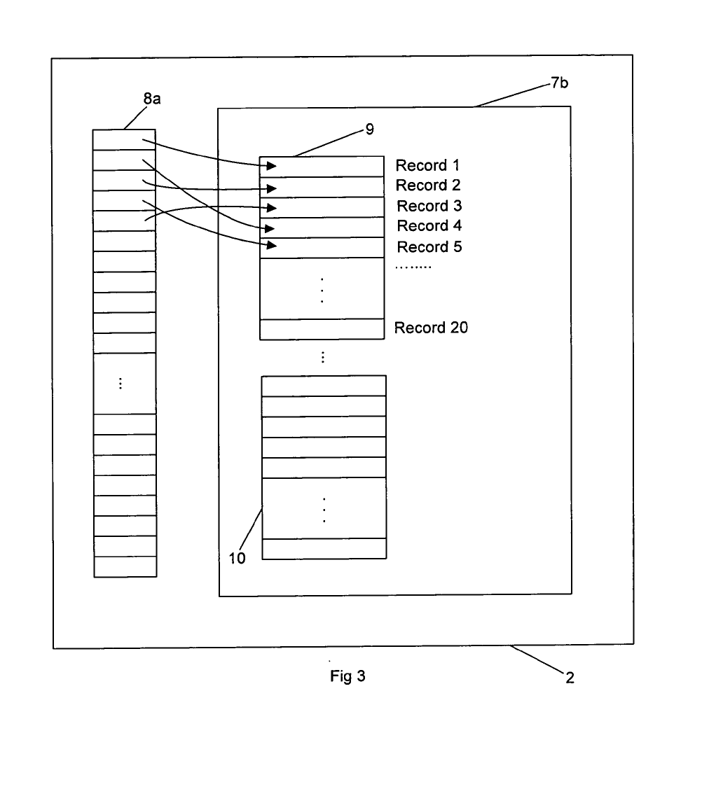

FIG. 3 shows pages 7b in further detail, together with an associated index 8a. As explained above, and as can be seen in FIG. 3, records are added to the page log comprising the pages 7b in the order of their creation or modification. That is, it can be seen that the pages 7b comprise a first page 9 storing twenty records, the twenty records having been added to the page 9 in order of their creation or modification. The index 8a references records in the first page 9 as described above, although only a subset of references is shown in FIG. 3 for the sake of simplicity.

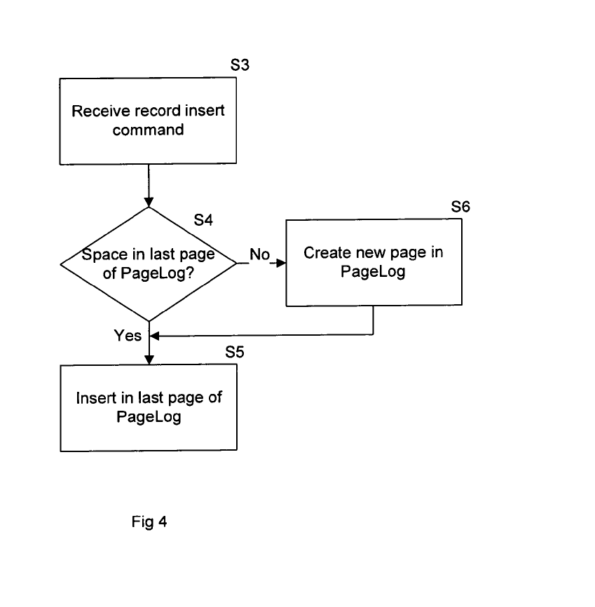

When the page 9 becomes full, it is copied from the main memory 2 to the secondary memory 3, and a new page is created, as is now described with reference to FIG. 4. At step S3 a command requiring insertion of a record in one of the pages 7b is processed. This insertion may arise either from creation of a new record, or modification of an existing record. At step S4 it is determined whether there is space in a currently ‘last’ page of the page log to hold the record which is to be inserted. If this is the case, processing passes to step S5 where the record is inserted in that ‘last’ page. If there is no such space, processing passes from step S4 to step S6 where a new page is created (shown in FIG. 3 as page 10) to hold the record which is being inserted, and this page becomes the ‘last’ page of the page log. Processing passes from step S6 to step S5 where the record is added to the new page.

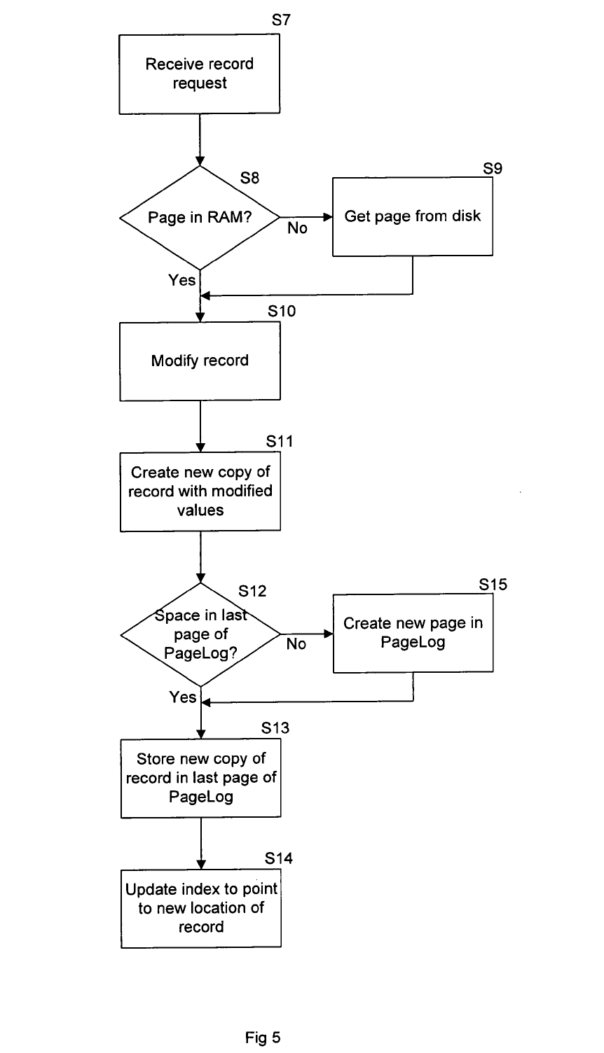

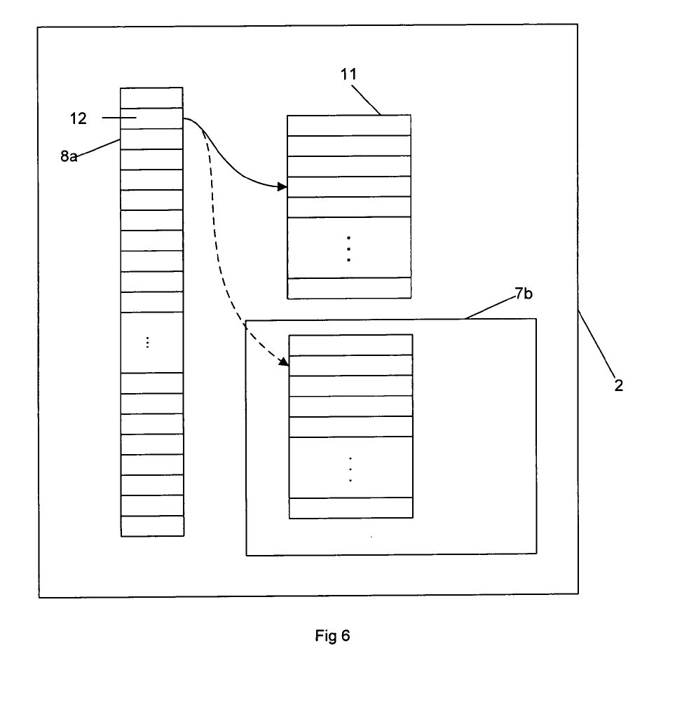

Processing carried out when a record is modified is now described with reference to FIGS. 5 and 6. Referring first to FIG. 5, at step S7 a request for a particular record is processed, and at step S8 a check is carried out to determine whether the particular record is stored in a page which is currently resident in the main memory 2. This check can be carried out by using the indexes 8a and 8b to identify a page within which the record of interest is stored, and determining whether the page in which the record of interest is stored is resident in the main memory 2. If it is not the case that the requisite page is resident in the main memory 2, the requisite page is copied to the main memory 2 from the secondary memory 3 at step S9. Where there is insufficient free space in the main memory 2 to accommodate the requisite page, one or more of the pages 7a currently resident in main memory 2 are ejected from main memory to provide sufficient free space. The choice of which of the page(s) 7a to eject may be based upon a First In, First Out (FIFO) selection policy.

FIG. 6 shows a possible state of the main memory 2 after the processing of step S9. It can be seen that a page 11 is stored in the main memory 2, the page 11 having been copied from the secondary memory 3. The page 11 stores the record requested at step S7 which is identified by an entry 12 in the index 8a.

Processing passes from the step S8 directly to step S10 if it is determined that the requisite page is stored in the main memory 2 and processing also passes from step S9 to step S10 after copying of the requisite page in the manner described above. At step S10 the record of interest is modified, and a new copy of the record containing the modified values is created at step S11. The record containing the modified values is to be stored in one of the pages 7b making up the page log. Processing therefore passes from step S11 to step S12 where a check is carried out to determine whether there is space in a ‘last’ page of the page log to hold the record containing the modified values.

If this is the case, processing passes to step S13 where the record containing the modified values is stored in the ‘last’ page of the page log. Having stored the record containing the modified values in the page log, the index 8a is updated at step S14 so that the entry 12 of the index 8a now references the last record in the ‘last’ page of the page log, as indicated by a broken line in FIG. 6. The link between the entry 12 of the index 8a and a record of the page 11 no longer exists.

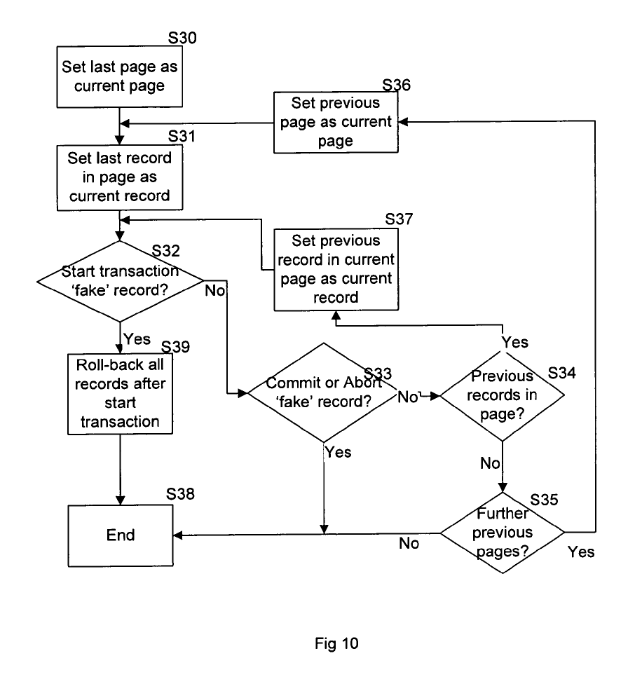

In some embodiments of the present invention, at step S11 the current rid of an index entry is saved in a “former value” field of the record, before the index is updated at step S14. As is described below with reference to FIG. 10, this allows changes to be rolled-back, for example in the event of a crash.

It will be appreciated that if at step S12 it is determined that there is insufficient space in the ‘last’ page of the page log, a new page in the page log is created at step S15, before processing continues at step S13 as described above.

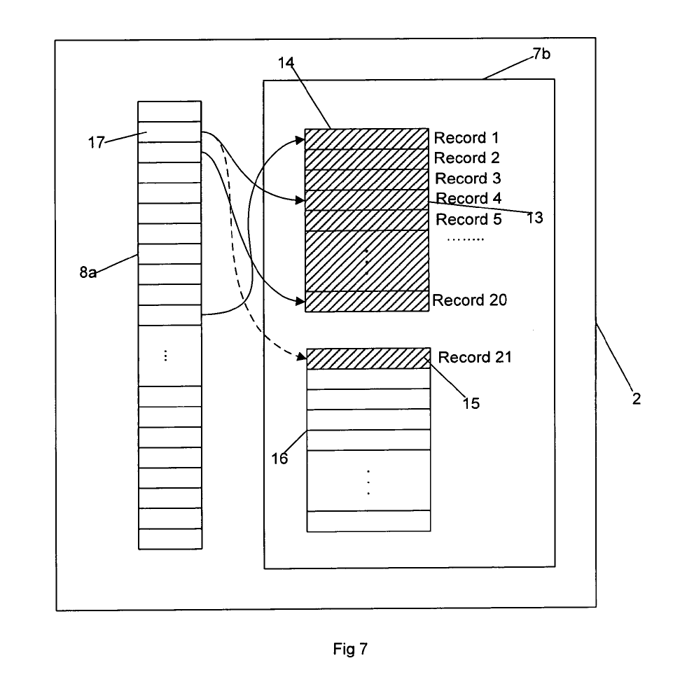

The preceding description has been concerned with modification of a record stored in a page which does not form part of the page log, but rather is copied from the secondary memory 3. It will be appreciated that in some cases records stored in a page of the page log present in the main memory 2 may be modified by processing of the type described with reference to FIG. 5. For example, referring to FIG. 7, a modification to a record 13 stored in a page 14 of the pages 7b making up the page log may be required. In such a case a record 15 is created in a page 16 representing the modifications, and the index 8a and more particularly an entry 17 in the index 8a is updated so as to reference the record 15.

From FIG. 7 it can also be seen that page 14 is full (i.e. has no further space in which records can be stored). As such, the page 14 is copied from the main memory 2 to the secondary memory 3.

From the preceding description it can be seen that all modifications to records of the database (including the creation of new records and modifications of existing records) are carried out by adding records to a currently ‘last’ page of a page log. As such, only pages of the page log need to be copied from the main memory 2 to the secondary memory 3 in order to ensure that all modifications are correctly stored in the secondary memory 3.

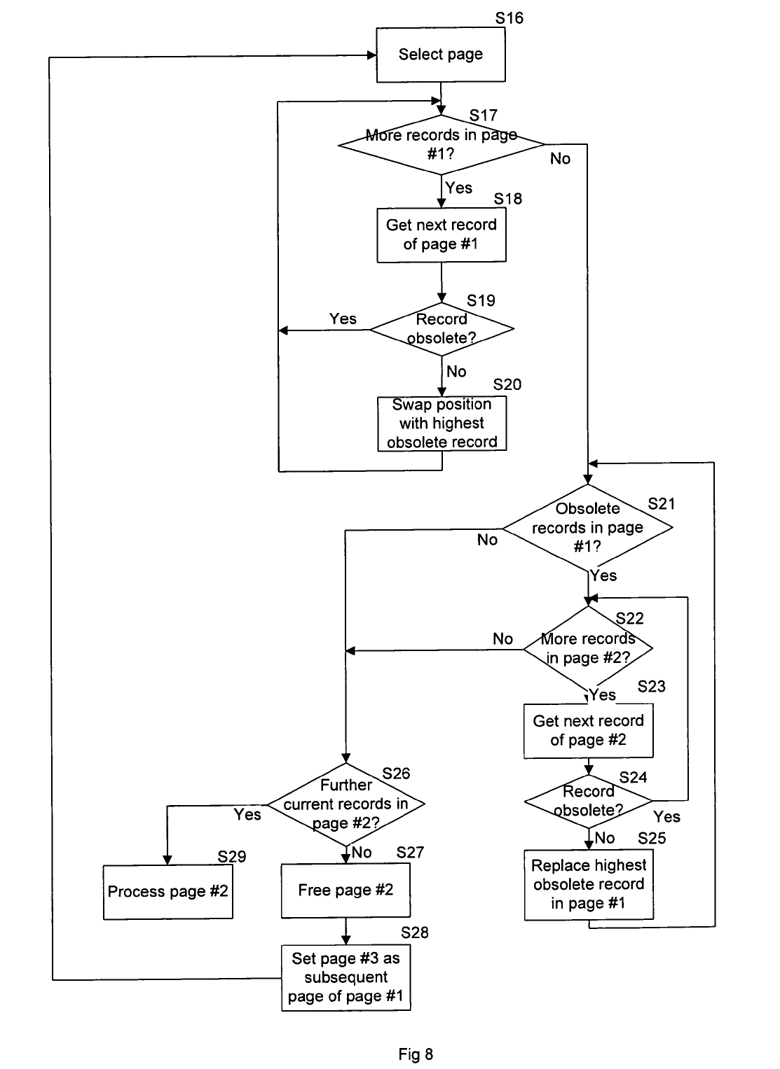

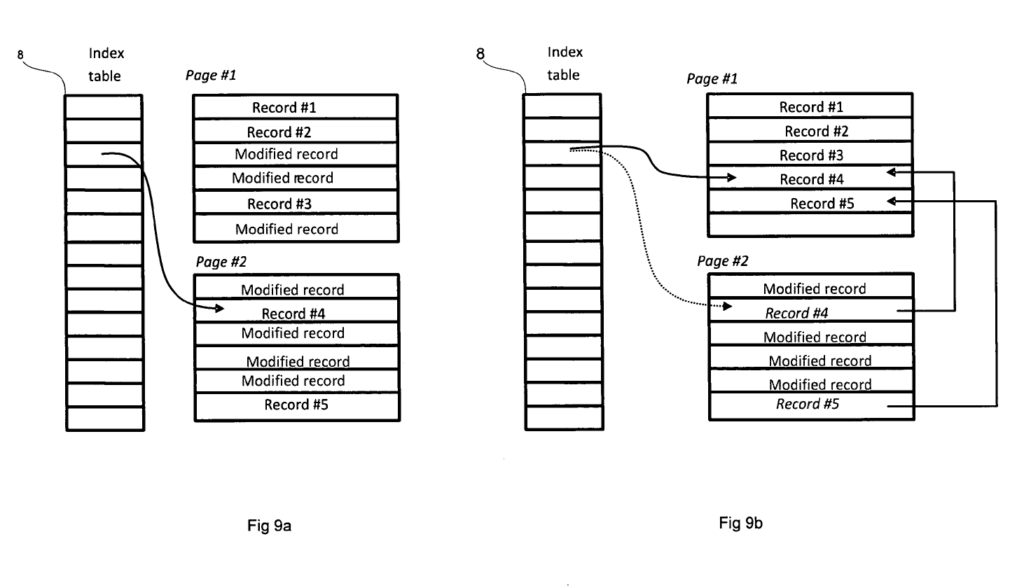

Given that all modifications are stored in a currently ‘last’ page of the page log, previous versions of records stored in other pages become obsolete, but continue to occupy storage space in the secondary memory 3. Given that the storage capacity of the secondary memory 3 is typically large (and larger than storage capacity of the main memory 2) this is not necessarily problematic. However, in some embodiments a process is implemented to identify obsolete records and delete them from the secondary memory as is now described with reference to FIGS. 8 and 9. The following description assumes that pages are ordered with respect to one another, and that each page includes a link to its immediately following page.

At step S16 a page is selected for processing. In the following description, the selected page is referred to as page #1, while its immediately following page is referred to as page #2. In some embodiments a page is selected at step S16 based upon a proportion of records which are obsolete (i.e. records which have been superseded) within that page. Such obsolete records can be identified by, for example, processing an index to identify records which are not referenced by any entry in the index. In more detail, for a record at a particular page and offset, the index may be searched to determine whether the index contains an entry having an rid corresponding to that page and offset. Where the index does not contain such a corresponding rid, the record is obsolete. Alternatively, it may be preferable to associate a time with each page, and to select an oldest page at step S16. Where pages are created using the techniques described above, pages will necessarily be created in a temporal order and as such selection of an oldest page is relatively straightforward.

Having selected a page at step S16 processing enters a loop defined by steps S17 to S20 in which all records of page #1 are processed in turn. At step S17 a check is carried out to determine whether there remain records to be processed within page #1.

If this is the case, processing continues at step S18. A next record is selected at step S18 and a check is carried out at step S19 to determine whether the record is obsolete. If this is the case, processing returns to step S17 and the loop continues. When a non-obsolete record is processed at step S19 this record is moved upwards within the page, to the highest position currently holding an obsolete record, at step S20. The record is moved upwards by copying its contents to the higher position within the page, and the space holding the record can then be indicated to be free space.

When it is determined at step S17 that all records in page #1 have been processed, processing passes to step S21 where a check is carried out to determine whether page #1 includes any obsolete records or free space (i.e. as a result of replacing an obsolete record with a current record at step S20). If, at step S21, it is determined that page #1 does include obsolete records or free space processing passes from step S21 to step S22 where a check is carried out to determine whether records remain to be processed in page #2, that being the page which immediately follows page #1. If records remain to be processed in page #2, processing passes from step S22 to step S23 where a next record in page #2 is selected for processing, before processing continues at step S24 where it is determined whether the selected record is obsolete. If the selected record is obsolete, processing passes from step S24 to step S22. If it is determined at step S24 that the selected record is not obsolete, the selected record is moved to the highest free position (i.e. the highest position storing an obsolete record, or highest free space) in page #1. Processing passes from step S25 back to step S21.

When it is determined at step S22 that page #2 includes no further records to be processed, processing passes from step S22 to step S26. Similarly, if it is determined, at step S21, that page #1 contains no obsolete records or free space, processing passes from step S21 to step S26.

At step S26 it is determined whether page #2 includes any current records. That is, it is determined whether all records in page #2 are obsolete (particularly following the possible copying of some records to page #1). If all records of page #2 are obsolete, page #2 can be freed as it no longer stores useful information. Page #2 is freed at step S27, and page #1 is modified at step S28 so as to identify its next page as the page which previously followed page #2 (referred to as page #3).

If, at step S26, it is determined that page #2 does include current records, processing passes from step S26 to step S29 where page #2 is processed using the processing described above (i.e. page #2 becomes page #1 for the purposes of the processing of FIG. 8).

In the preceding processing, pages which are to be processed are copied from the secondary memory 3 to the main memory 2. Any page which is modified by the described processing is copied back to the secondary memory 3 for persistent storage. In the event of a system crash, some records may be duplicated between pages. If it is desired to identify and eliminate such duplicates, this can be achieved by associating a log number with each record. Such a log number may be initialized when the record is created at step S11 of FIG. 5.

The processing of FIG. 8 can be implemented using a low priority process arranged to ensure that obsolete records are deleted from time to time, thereby avoiding excessive secondary memory storage requirements.

FIGS. 9a and 9b shows examples of pages #1 and #2 before and after the processing described above with reference to FIG. 8.

In FIG. 9a it can be seen that page #1 stores six records, but three of these records are in fact obsolete. Page 2 stores only two non-obsolete records (records #4 and #5). FIG. 9b shows that after the processing described above, records #4 and #5 have been moved into page #1 such that page #2 stores only obsolete records, and page #2 can therefore be freed.

FIGS. 9a and 9b show that an index 8 references records in pages #1 and #2. The processing carried out amends the index entries. For example, an index entry referencing record #4 in its position in page #2 in FIG. 9a references record #4 in its position in page #1 in FIG. 9b.

In some embodiments, a record is not considered obsolete if it is a version which immediately precedes the current version of the record. This allows roll-back operations to be correctly carried out in the event of a system crash. For example, a record may not be considered obsolete where that record is part of an uncommitted transaction. Transactions are described in more detail below.

In RDBMS some sets of operations affecting particular records are executed in such a way as to ensure Atomicity, Consistency, Integrity and Durability (sometimes referred to as ‘ACID’ properties). In general terms, this means that the set of operations should be executed in its entirety, or if this is not possible should be totally aborted. That is, it should not happen that only a subset of these operations is executed while others of the operations are not executed. The set of operations which must all be executed is often referred to as a transaction.

In known database management systems, transaction atomicity is ensured using a log file. That is, in known database management systems, a transaction's commit point is the point at which the transaction has been executed successfully and the effect of the transactions have been recorded in a log file stored on secondary memory, such that the effects of the transaction can be reproduced in the event of a system failure. Generally, checkpoint entries are added to the log file when operations forming part of committed transactions are written to the database in secondary memory, to avoid reading the whole log file when recovering the RDBMS from a crash.

When a transaction is completely executed, a commit procedure is executed and a “transaction committed” message is sent to user application to notify the successful end of all operations contained in the transaction and the durability of the operations. Otherwise a rollback procedure is invoked returning all records contents to the values they have just before the transaction started to execute. At the end of a rollback procedure the user application is also notified of the failure of transaction execution.

In the system of the present invention, a transaction's commit point is the point at which all of the operations making up that transaction have been written to secondary memory from the page log and the index has been updated to point to the new records.

If transactional atomicity is needed, the methods described above may be modified, to provide a simple checkpoint procedure so as to avoid reading all database pages when recovering from a system crash. This can be achieved by including within pages “fake” transaction records containing information relating to the beginning and completion of transactions. More particularly, these “fake records” indicate transaction start, transaction commit and transaction abort. For example, a ‘start transaction’ record may be inserted into the page log to indicate that the operations which follow the ‘start transaction’ record are part of a single transaction, and a ‘commit’ record can be written to the page log immediately after the final operation in that transaction. Similarly, if a transaction is aborted, an ‘aborted’ record can be written to the page log immediately after the last operation before the transaction is aborted.

When a system crash occurs, records are processed in reverse order to identify transaction start records which do not have a corresponding transaction commit or transaction abort record. If any such transaction start records are encountered, all records following the transaction start record are discarded, and the index entries associated with those records are set to point to the previous position of those records in the database using the ‘former value’ field of the record.

FIG. 10 shows an example of processing which can be carried out in the event of a system crash (for example, in the event of a loss of power), in which data is lost from main memory 2.

At step S30, the last page of the pages stored in secondary memory 3 (that is, the last page committed to secondary memory before the system crash) is retrieved and set as the current page. At step S31, the last record of that page is set as the current record. At step S32 it is determined whether the current record is a start transaction record. If the current record is not a start transaction record, processing passes to step S33, where it is determined if the current record is a commit or an abort record.

If at step S33 it is determined that the current record is not a commit or an abort record, processing passes to step S34 at which it is determined whether there are previous records in the current page. If, at step S34 it is determined that there are no previous records in the current page, processing passes to step S35 and it is determined whether there are any previous pages (i.e. if the current page is the first page that was committed to second memory, there will be no previous pages). If it is determined that there are no further previous pages, processing passes from step S35 to end at step S38.

If, on the other hand, it is determined at step S35 that there are further previous pages, processing passes from step S35 to S36 and the previous page (i.e. the page immediately preceding the current page) is set as the new current page. Processing passes from step S36 to step S31.

If, at step S34, it is determined that there are previous records in the current page, processing passes to step S37, at which the record preceding the current record in the current page is set as the new current record. Processing passes from step S37 to step S32.

If, at step S33, it is determined that the current record is a commit, or an abort, record, this indicates that there is no need to roll-back any of the records stored in the database and processing ends at step S38. That is, if an abort or a commit record is encountered at step S33, this indicates that there are no records in the database which are part of an unfinished transaction.

If, at step S32, it is determined that the current record is a start transaction record, processing passes to step S39 at which all records following the current record (i.e. added to the database after the start transaction record) are rolled-back. Processing passes from step S39 to end at step S38.

It will be appreciated that the processing described with reference to FIG. 10 includes an implicit checkpointing procedure, as processing will always end when it is not necessary to process every record in the database when recovering from a system crash as processing will always end upon finding a commit or an abort fake record. In general therefore, it will not be necessary to process every record in the database.

It will further be appreciated that the terms database and computer are to be construed broadly and are not limited to any particular implementations thereof. Various modifications and applications of the present invention will be readily apparent to the appropriately skilled person from the teaching herein, without departing form the scope of the appended claims.

1. A method for storing data in a database in a system comprising a first memory and a second memory, the method comprising:
reading a first page of data from the second memory;
modifying at least part of the data read from said second memory to create modified data to be stored in said database;
writing the modified data to a second page of data in the first memory; and
copying said second page from the first memory to the second memory;
wherein data in said second page is sequentially ordered based upon the order in which said data was modified.

2. A method according to claim 1, wherein writing the modified data to said second page comprises appending said data to data previously written to said second page.

3. A method according to claim 1 or 2, wherein the first and second pages of data contain a plurality of database records, and wherein the modified data comprises one or more database records.

4. A method according to claim 3, wherein the modified data which is written to the second page comprises data based at least in part upon at least part of one of the records of the first page.

5. A method according to claim 4 wherein an index references records in said first page read from said second memory, and the method further comprises: modifying an entry in said index to reference said second page to which said modified data is written.

6. A method according to claim 3, further comprising adding to said second page a new database record, not contained in the read first page, comprising new data to be stored in said database.

7. A method according to any preceding claim, wherein a further second page is created when a predetermined quantity of data has been written to said second page and wherein data stored in said further second page is sequentially ordered based upon the order in which said data is modified.

8. A method according to any preceding claim, wherein said second page is copied to said second memory when a predetermined quantity of data has been written to said second page.

9. A method according to any preceding claim wherein said first memory has a first associated access time and said second memory has a second associated access time, with regard to data read and/or write operations, and said first access time is less than said second access time.

10. A method according to any preceding claim, further comprising:
processing a plurality of pages stored in said second memory to identify obsolete and non-obsolete versions of the same data included in said plurality of pages;
rearranging data within a first one of said plurality of pages so that non-obsolete data is contiguously arranged;
copying non-obsolete data from another of said plurality of pages to said first one of said plurality of pages, overwriting obsolete data in said first one of said plurality of pages but maintaining non-obsolete data in said first one of said plurality of pages.

11. A method according to any preceding claim, further comprising, storing in said second page data indicating transaction commencement and completion.

12. A method according to claim 11, further comprising processing said data indicating transaction commencement and completion to identify partially executed transactions.

13. A method according to any preceding claim, further comprising:
reading said data stored in said second page;
modifying said data read from said second page; and
writing said modified data to said second page or to a further second page without affecting the data which was read.

14. A computer readable medium carrying computer readable instructions configured to carry out a method according to any preceding claim.

15. Computer apparatus for storing data, the apparatus comprising:
a first memory;
a second memory; and
a processor configured to communicate with said first and second memory, so as to read and write data to and from each of said first and second memories, and to perform the method claimed in anyone of claims 1 to 13.
